(19) United States
(12) Patent Application Publication
(10) Pub. No.: US 2004/0247887 A1
(43) Pub. Date: Dec. 9, 2004

(54) System and method for coloring a spray urethane skin for vehicle interior trim components and particles made thereby

(75) Inventors: Joseph T. Donatti, Howell, MI (US); Robert J. Adams, Ypsilanti, MI (US); Glenn A. Cowelchuk, Chesterfield, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI

(21) Appl. No.: 10/454,143

(22) Filed: Jun. 4, 2003

(51) Int. Cl. B32B 27/00; B32B 27/40; B29C 45/16

(52) U.S. Cl. 428/423.1; 264/328.6; 264/245; 264/255; 425/103

(57) ABSTRACT

A system and method of making polyurethane skins for interior components is provided wherein a colorant/polyol mixture is injected into a polyurethane layer to provide color in the polyurethane layer. An in-mold coating may be applied to the mold over which the polyurethane layer is sprayed. The colorant/polyol mixture is combined to match the color of the in-mold coating. The colorant/polyol mixture is injected into the same spray applicator that dispenses polyol and isocyanate of a two part polyurethane forming mixture. The colorant may be selectively injected into the spray applicator to selectively provide color in the polyol and isocyanate composition that matches the color of the in-mold coating.

### BACKGROUND OF THE INVENTION

1. Field of the Invention

The present invention relates to polyurethane skins for vehicle interior trim components and method and systems for manufacturing such skins.

2. Background Art

Skins for interior trim components provide a durable plastic cover for interior trim component structures and their associated foam padding. Vinyl skins for interior trim components of a vehicle are made by rotocasting a liquid vinyl composition in a heated mold as it is rotated. It has been proposed and implemented in production processes to add liquid color concentrates into the liquid vinyl composition that is provided to rotational molds in rotational molding operations for armrests and small trim components. Vinyl rotocasting processes are labor intensive and are difficult to control and can result in parts having substantial variations in skin thickness. Vinyl skins are not readily recycled and tend to harden over time that may lead to splits in the skin surface over the life of the vehicle.

Recently, substantial efforts have been made to develop polyurethane skins for interior trim components. Polyurethane skins may be sprayed in a robotic spraying process that may be computer controlled to obtain uniform skin thickness. Aromatic polyurethane compositions are generally black or gray in color but may also be untinted resulting in an amber color. Aliphatic polyurethane compositions may be provided in many different colors. To assure precise color matching a vehicle interior component an in-mold coating is preferably applied to the polyurethane skin forming mold prior to spraying the polyurethane composition over the in-mold coating and onto the mold surface. Examples of interior components that may be made by the polyurethane spray forming operation include instrument panels, glove box doors, knee bolsters, door panels and other interior trim components.

Some vehicle interior components have complex shapes and may include difficult to access areas. For example, instrument panel brows may include a narrow section that cannot be easily and completely coated with an in-mold coating composition. Excessive in-mold coating material that may be applied to the surface the material is wasted and may form runs or irregularities that can adversely effect part quality. In difficult to access areas, the in-mold coating may have gaps through which the polyurethane skin material may be visible. If so, it may be necessary to paint the skins after forming in areas where there polyurethane skin is visible through the in-mold coating. Such post painting operations are labor intensive and require capital investment for post painting operation stations.

There is a need for a flexible and cost effective method of spray forming polyurethane parts with a continuous and complete color even where the in-mold coating for the parts has gaps or areas of inadequate coverage.

The above problems and needs are addressed by applicant's invention as summarized below.

### SUMMARY OF THE INVENTION

According to one aspect of the present invention a system for manufacturing polyurethane skins for vehicle interior components is provided. According to the system, a source of polyol and a pump deliver a stream of plain, uncolored polyol under pressure through a first delivery circuit to a spray applicator. A source of isocyanate and a pump deliver a stream of isocyanate under pressure through a second fluid delivery circuit to the spray applicator. A pump injects a stream of a colorant and polyol mixture (colorant/polyol) under pressure through a third fluid delivery circuit to the spray applicator. A polyurethane mold having a mold surface is sprayed by the spray applicator with the mixture of polyol, isocyanate, and colorant/polyol to form the polyurethane skins.

Alternatively, the colorant may be selectively injected to color the mixture sprayed on the mold surface in selected areas of the mold surface.

According to other aspects of the system of the present invention, the color injection system is ported to the spray applicator that has a mixing chamber wherein the stream of polyol, isocyanate, and colorant/polyol are initially combined. An in-mold coating may be sprayed on the mold surface prior to applying the polyol and isocyanate. The mold surface to which the present invention applies may have difficult to access portions that are not consistently covered by the in-mold coating. The colorant may be injected when the difficult to access portions of the mold are sprayed with the mixture of polyol and isocyanate. The difficult to access areas of the mold generally correspond to the selected areas where the colorant is selectively injected. The system also may include a control system for controlling the application of the colorant/polyol by the spray applicator and to control where the colorant/polyol is selectively injected.

According to another aspect of the method of making polyurethane skins of the present invention, vehicle interior components are made that have a visually consistent surface color. A mixture of polyol and isocyanate are sprayed on the mold to form a polyurethane skin. A colorant/polyol mixture is injected into the mixture of polyol and isocynate. The colorant/polyol mixture can produce a skin having the desired color.

The method may also be practiced with a selective coloring approach on a mold having open areas and restricted areas. The mixture of polyol and isocyanate is applied directly to the mold surface in the restricted areas to the extent that the in-mold coating does not fully cover the mold surface. The colorant/polyol mixture is selectively injected to color the polyol and isocyanate streams to match the color of the in-mold coating. The colorant colors the mixture in the restricted areas where the in-mold coating may not fully cover the mold surface so that the polyurethane skin is produced that has the desired consistent surface color.

According to other aspects of the method, polyol and isocyanate are mixed in a spray applicator that receive separate streams of polyol and isocyanate from the first and second pressurized fluid systems, respectively. The polyol and isocyanate streams are recirculated by the first and second fluid systems if they are not mixed and dispensed by the spray applicator. The colorant/polyol mixture may be provided by a third pressurized fluid system that also recirculates the colorant/polyol mixture if not dispensed.

The invention may also be characterized as a polyurethane skin for an interior component of a vehicle. The polyurethane skin comprises a molded polyurethane layer having a first color. If the in-mold coating does not completely cover the polyurethane layer the polyurethane layer may be visible through portions of the in-mold coating. A colorant having a color corresponding to the color of the in-mold coating is provided in the molded polyurethane layer where the polyurethane layer is visible through the portions of the in-mold coating. According to other aspects of the invention as it relates to the polyurethane skin, the in-mold coating is preferably an aromatic polyurethane composition. The polyurethane layer may either be an aliphatic polyurethane composition or an aromatic polyurethane composition.

These and other aspects of the present invention will be readily understood by one of ordinary skill in the art in view of the attached drawings and following detailed description of the preferred embodiments of the present invention.

### BRIEF DESCRIPTION OF THE DRAWINGS

FIG. 1 is a schematic elevation view, partially in section, of one embodiment of a spray applicator assembly;

FIG. 2 is a cross-sectional view taken along the line 2-2 in FIG. 1;

FIGS. 3 and 4 are cross-sectional views taken along the line 3-3 in FIG. 1 showing the mix head with the metering rod in a recirculating and in a dispensing position, respectively;

FIG. 5 is a fragmentary perspective view of a polyurethane skin having a partial in-mold coating with a portion of the polyurethane skin visible through the in-mold coating.

### DETAILED DESCRIPTION OF THE PREFERRED EMBODIMENTS

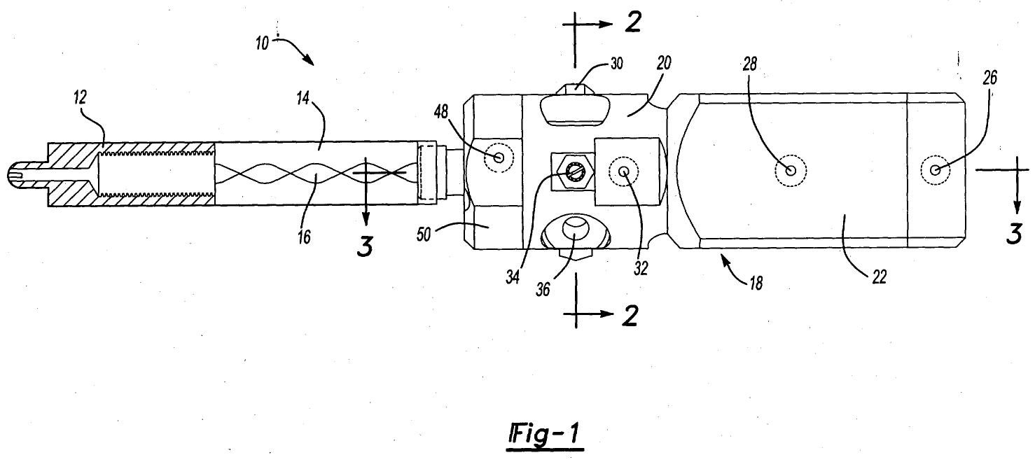

Referring now to FIG. 1, a spray applicator assembly is generally indicated by reference numeral 10. The spray applicator assembly 10 comprises a nozzle 12 that is connected to a mixing tube 14. The mixing tube 14 may have a helical mixing element 16 that promotes mixing in the mixing tube 14 of fluids dispensed by a mix head 18. Mix head 18 is attached to a main body 20 of the mix head 18. The mix head 18 is attached to a shunk (not shown) that is adapted to be received by a robot arm (not shown).

A control fluid is ported to inlet 26 and outlet 28 that are provided in the rear portion 22 of the mix head 18. The control fluid is preferably hydraulic fluid but could also be air.

A polyol inlet 30 is connected to a source of polyol such as a tank (not shown) from which polyol is drawn by a pump (not shown) and provided under pressure to the mix head 18. A polyol recycle port 32 is provided in the mix head 18 for returning polyol to its source if it is not dispensed by the spray applicator assembly 10. A polyol metering needle 34 may be adjusted to control the flow rate at which polyol is dispensed from the polyol inlet 30. A colorant/polyol inlet 36 is also illustrated in FIG. 1.

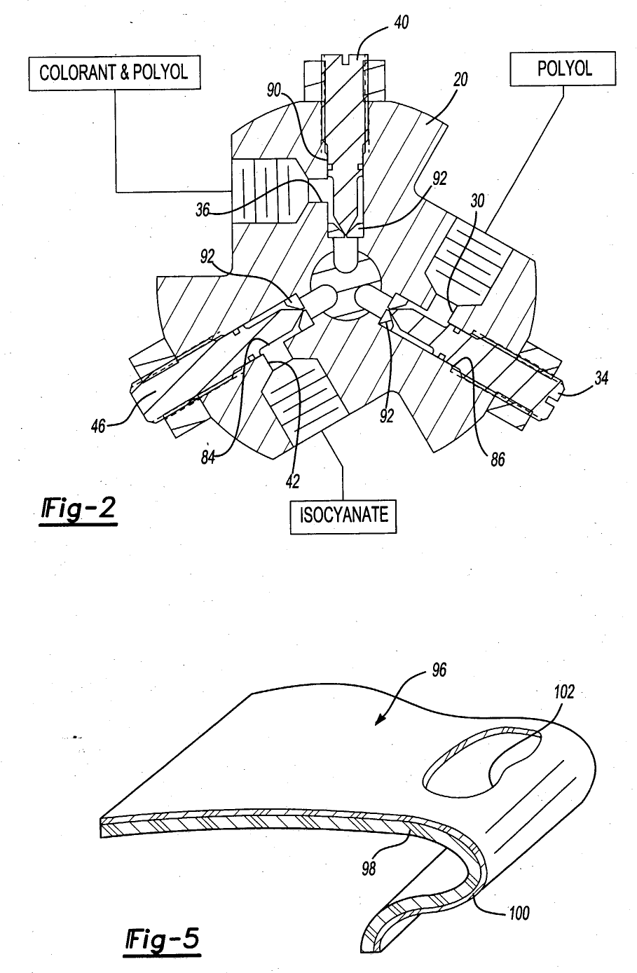

Referring now to FIG. 2, the construction of the mix head is shown in greater detail. A colorant/polyol metering needle 40 controls the flow rate at which colorant/polyol is dispensed from the colorant/polyol inlet 36. The colorant includes a zinc barium based UV stabilizer, or the like. An isocyanate inlet 42 is controlled by isocyanate metering needle 46. The mix head 18 is adapted to receive three different streams for mixture prior to being dispensed through the nozzle 12 of the spray applicator assembly 10. Metering needles 34, 40 and 46 may be advanced or retracted to control the flow of the mixed components into the mix head 18.

Referring back to FIG. 1, a solvent flush port 48 is provided in the mixing cap 50. The spray applicator assembly 10 is periodically flushed with solvents that are appropriate for the components mixed in the mix head 18.

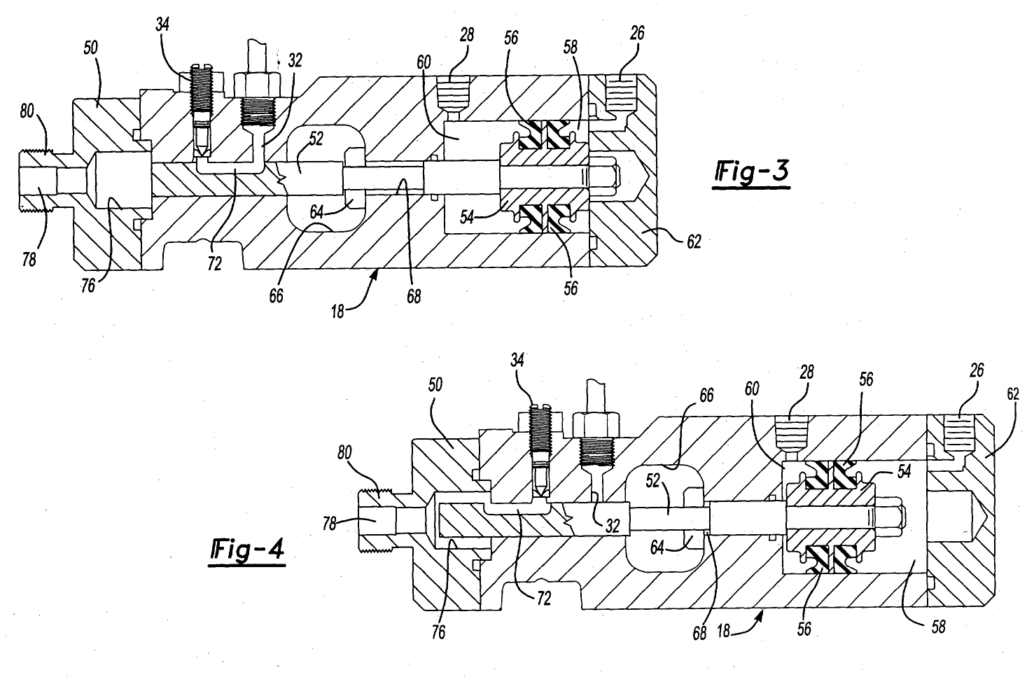

Referring now to FIGS. 3 and 4, the mix head 18 has a metering rod 52 that is shifted along its axis by means of an actuation piston 54. Actuation piston 54 has seals 56 that separate a rear chamber 58 from a front chamber 60. The inlet 26 ports fluid to the rear chamber 58 while the outlet 28 ports fluid to the front chamber 60. An end cap 62 closes the rear chamber 58 and may be removed to provide access to the actuation piston 54. A piston guide 64 is provided in a piston guide chamber 66. Piston guide 64 guides the piston movement. Guide slots 68 are formed in the mix head 18 to keep the metering rod 52 in circumferential alignment.

A fluid dispensing channel 72 is formed in the metering rod 52. As shown in FIG. 3, the metering rod is in its recirculating position wherein the fluid dispensing channel 72 connects the polyol to flow from the polyol inlet 30 through the fluid dispensing channel 72 and to the polyol recycle port 32. As shown in FIG. 4, the metering rod is in its dispensing position and the fluid dispensing channel 72 is shifted to provide polyol to the mixing chamber 76. Mixing chamber 76 is provided in the mixing cap 50. Three fluid dispensing channels 72 are provided in the metering rod 52, one for the polyol as shown, one for isocyanate, and one for a mixture of colorant and polyol. The structure of the isocyanate and colorant/polyol fluid dispensing systems are essentially identical to the polyol components shown in FIGS. 3 and 4.

The mixing chamber 76 receives the three streams of material and mixes them initially within the mixing chamber 76. A mixing chamber outlet 78 is provided in a threaded nipple 80 that is adapted to be secured to the mixing tube 14.

Referring back to FIG. 2, the structure of the mix head is described in greater detail. An isocyanate needle receptacle 84 is provided for isocyanate metering needle 46, a polyol needle receptacle needle 86 is provided for polyol metering needle 34, and a colorant/polyol receptacle 90 is provided for the colorant/polyol metering needle 40. Orifice seals 92 are provided at the interior ends of the receptacles 84, 86 and 90. The orifice seals 92 are contacted by the metering needles 34, 40 and 46. The needles can be adjusted to close off flow by fully engaging the orifice seals 92 or may be retracted to permit fluids to flow through the orifice seals 92.

Referring now to FIG. 5, a polyurethane skin composite 96 made according to the method of the present invention, is shown. The polyurethane skin composite 96 has restricted access areas that correspond to areas of the mold that are difficult to reach such as the brow portion of an instrument panel cover. The polyurethane skin composite comprises a skin body portion 98 and an in-mold coating 100 that is provided over the face of the skin body portion 96. Gaps 102 in the in-mold coating 100 may be found in restricted access areas. The skin body portion 98 may be visible in the gaps 102 so the skin body portion 98 is colored by means of the injected colorant/polyol that color the polyurethane skin 96 to reduce the visibility of any color differential between the skin body portion 96 and the in-mold coating 100.

The polyol, isocyanate and colorant/polyol components are provided to the spray applicator assembly 10 under pressure. For example, each of the streams may be provided at a pressure of between 600 psi and 2,000 psi to the spray applicator assembly 10.

The colorant/polyol stream comprises a pigmented urethane colorant composition comprising approximately 30% colorant and 70% polyol. The colorant/polyol is injected into the stream of isocyanate and polyol at a controlled rate to provide a final composition having between 1 and 5%, and most likely approximately 2% of colorant as a percent weight of the final mixture.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for manufacturing polyurethane skins for vehicle interior components, comprising:
a source of a polyol and a pump for delivering a stream of the polyol under pressure through a first fluid delivery circuit to a spray applicator;
a source of an isocyanate and a pump for delivering a stream of the isocyanate under pressure through a second fluid delivery circuit to the spray applicator;
a source of a colorant/polyol mixture and a pump for injecting a stream of the colorant/polyol under pressure through a third fluid delivery circuit; and
a mold having a mold surface toward which a mixture of polyol, isocyanate, and colorant/polyol are sprayed by the spray applicator to form the polyurethane skins.

2. The system of claim 1 wherein the colorant/polyol mixture is ported to the spray applicator, the spray applicator having a mixing chamber wherein the stream of polyol, isocyanate, and colorant/polyol are initially combined.

3. The system of claim 1 wherein an in-mold coating is sprayed on the mold surface, wherein the mold surface has difficult to access portions that are not consistently covered by the in-mold coating, and wherein the colorant/polyol mixture is selectively injected for coloring the mixture sprayed on the mold surface in select areas of the mold surface.

4. The system of claim 3 wherein the colorant/polyol mixture is injected when the difficult to access portions of the mold are sprayed with the mixture of polyol, isocyanate, and colorant/polyol mixture.

5. The system of claim 1 wherein a plurality of different colorant/polyol mixtures are provided in a plurality of different colors.

6. The system of claim 1 further comprising a control system for controlling the application of polyol and isocyanate by the spray applicator, and also controls where the colorant/polyol mixture is selectively injected.

7. A method of making polyurethane skins for interior components comprising supplying a first stream comprising a polyol, a second stream comprising an isocyanate and a third stream comprising a colorant/polyol mixture to a mixing chamber to form a colored polyurethane forming spray mixture that is sprayed onto a mold to form the polyurethane skin.

8. The method of claim 7 further comprising applying an in-mold coating to a mold surface having open areas and restricted areas, the in-mold coating being a specific color, wherein the third stream is injected into the first and second stream and applied directly to the mold surface in the restricted areas to the extent that the in-mold coating does not fully cover the mold surface, the colorant corresponding to the color of the in-mold coating, wherein the third stream colors the polyurethane skin in the restricted areas where the in-mold coating may not fully cover the mold surface so that a polyurethane skin having visually consistent surface color is obtained.

9. The method of claim 7 wherein the first, second and third streams are supplied by separate pressurized fluid systems, respectively.

10. The method of claim 9 wherein the first, second and third streams are recirculated if they are not mixed and dispensed.

11. A polyurethane skin for an interior component for a vehicle, comprising:
a molded skin body layer being at least one color; and
an in-mold coating layer being essentially the same color as the molded skin body layer and being applied to one side of the skin body layer, the in-mold coating layer not completely covering the skin body layer, wherein the skin body layer is visible through any gaps in the in-mold coating layer.

12. The polyurethane skin of claim 11 wherein the in-mold coating is polyurethane composition.

13. The polyurethane skin of claim 11 wherein the skin body layer is a two-part aromatic polyurethane composition.

14. The polyurethane skin of claim 11 wherein the skin body layer is colored selectively in areas where the in mold coating tends to not completely cover the polyurethane layer.
